(19) United States
(12) Patent Application Publication
(10) Pub. No.: US 2012/0290498 A1
(43) Pub. Date: Nov. 15, 2012

(54) Methods for Strategic Asset Allocation by Mean Reversion Optimization

(76) Inventor: Michael Jones, Midlothian, VA (US)

(21) Appl. No.: 13/072,055

(22) Filed: Mar. 25, 2011

(51) Int. Cl. G06Q 40/06

(52) U.S. Cl. 705/36 R

(57) ABSTRACT

The invention is directed to a computer implemented method of determining the optimal asset allocation strategy for an investment portfolio. The optimization methodology is premised on computerized mathematical models that relate the distance from the long-term market trend at the beginning of historical periods to the returns investors ultimately receive over subsequent periods. The method incorporates a tendency of asset prices to revert to their long term trend over longer investment horizons. Applying this concept to optimizing asset allocation strategies required building software for configuring a computer to replicate this mean-reverting behavior within an optimization process and determine the distribution of expected returns from a current distance from trend.

### FIELD OF THE INVENTION

The invention is directed to a method of determining the optimal asset allocation strategy for an investment portfolio. The optimization methodology is premised on mathematical models that relate the distance from the long-term market trend at the beginning of historical periods to the returns investors ultimately receive over subsequent periods, incorporating the tendency of asset prices to revert to their long term trend over longer investment horizons. Applying this concept to optimizing asset allocation strategies required building software that could replicate this mean-reverting behavior within an optimization process.

### BACKGROUND

Investment portfolios are typically based upon an asset allocation strategies tailored to the investment objective and risk tolerance of the investor. Determining the correct asset allocation strategy for an investor has proven to be difficult. As with virtually every aspect of financial-market analysis, no consensus currently exists as to the “right” way to calculate expected returns and determine other capital market assumptions (CMAs). Industry standard methodologies take on various forms but are typically built upon the pioneering work of Nobel Laureate Harry Markowtiz. These models of expected return assume that equity market returns follow a “random walk.” Under random walk theory, market prices perfectly incorporate all known information and therefore the current valuation level of the market has no impact on expected returns and downside risks. As such, whether equity prices have been inflated by a speculative bubble (as in 1999) or deflated by a deep bear market (as in early 2009), the expected long-term return for large cap stocks remains virtually unchanged. Thus under random walk assumptions, the best estimate for future market returns is the average annual market return over some historical period.

In addition to defining how expected returns should be defined and calculated, Markowtiz also established the industry standard definition of risk. To Markowitz (and most asset allocation models), risk is defined as the standard deviation, or volatility, of annual returns. As with expected returns, risk is assumed to be unconnected to market valuation levels. By combining asset classes with less than perfect correlation into the portfolio, Markowitz theorized that portfolio returns could be improved without increasing the standard deviation of portfolio returns (higher return for the same degree of risk). Thus, industry standard optimization processes require a set of capital market assumptions (CMAs) defined as an expected average annual return, volatility of that return and the correlation of every asset class in the optimization to every other asset class (a covariance matrix).

The expected returns, volatility estimates and a covariance matrix produced by the above process (or any of a myriad of processes that vary in details but build upon similar theories) are input into a mean variance optimization tool. Mean variance optimization (MVO) uses the input estimates to calculate the combination of asset classes that maximizes expected 1-year (or 1 period) returns for each level of potential portfolio volatility.

A variation on the MVO methodology is resampling optimization, in which the each input CMA is assumed to be drawn from a distribution of potential CMAs. A resampling process uses Monte Carlo simulation to take this uncertainty in CMA values into account within the optimization. However, both mean variance optimization and resampling methodologies build upon the core concepts of optimizing random one period returns subject to a level of risk measured by the standard deviation of one period returns.

There exists a need for an improved method of determining the optimal asset allocation for an investment portfolio. There further exists a need for a method of better measuring portfolio risk and therefore the optimal tradeoff between risk and potential return.

### SUMMARY

Embodiments of the method are directed to a computer implemented method of setting an asset allocation strategy, comprising calculating a current difference from trend between a current value of an asset class and the current value predicted by a historic trend line of the value of the asset class for multiple asset classes. The returns of a particular asset class have responded somewhat predictably from points in history having similar differences from the historic trend line. Therefore, it is beneficial to develop a distribution of expected returns based upon this current difference from trend for multiple asset classes. Embodiments of the method may comprise estimating an expected distribution of asset class future values for multiple investment periods, wherein the expected asset class future values are derived from historical responses of the asset class to the current difference from trend for each investment period and the degree of mean reversion historically observed in each asset class.

Historically, asset classes have responded somewhat predictably to market conditions, with periods starting well below the long term trend tending to produce above average returns and periods beginning well above the long term trend producing below average returns as markets revert to their long term trend. However, due to random walk theory asset allocation strategies tend to be derived using long term average capital market assumptions, with capital market assumptions remaining the same irrespective of market valuation and with optimization techniques that never vary expected returns. This is a weakness of current models and adjustment of capital market assumption would refine asset allocation strategy methods. Therefore, embodiments of the computer implemented method of setting an asset allocation strategy may comprise calculating expected distribution of asset class future values by a monte carlo method for multiple asset classes using capital market assumptions premised on the initial distance from trend for each asset class, and wherein the capital market assumptions of a subsequent monte carlo trial are recalculated based upon the results of the previous monte carlo trial.

The invention is directed to a computer implemented method of setting an asset allocation strategy for an investment portfolio. A computer may be configured to calculate the trend line of historic values of an asset class, calculate the difference from trend of an asset class, a distribution of expected future returns of the asset class based upon the historic response of the asset class to the difference from trend, calculating the expected future value for multiple investment periods, calculating the expected future value after a second investment period based upon the results of the first investment period, and/or adjusting capital market assumptions based upon the results of the calculation after the end of the first investment period. The computer has associated processing capability and memory storage capable of storing the inputs, intermediate results and the final results of the calculations.

Other aspects and features of embodiments of the method will become apparent to those of ordinary skill in the art, upon reviewing the following description of specific, exemplary embodiments of the present invention in concert with the figures. While features may be discussed relative to certain embodiments and figures, all embodiments can include one or more of the features discussed herein. While one or more particular embodiments may be discussed herein as having certain advantageous features, each of such features may also be integrated into various other of the embodiments of the invention (except to the extent that such integration is incompatible with other features thereof) discussed herein. In similar fashion, while exemplary embodiments may be discussed below as system or method embodiments it is to be understood that such exemplary embodiments can be implemented in various systems and methods.

### BRIEF DESCRIPTION OF THE FIGURES

FIG. 1 depicts the real total return of the stock of large cap companies over a period starting in the year 1926 and ending in the year 2009;

FIG. 2 is a graph of the ten year return on stocks of large cap companies versus the distance from the long term trend line of large cap stocks at the beginning of the ten year return period; and

FIG. 3 is graph comparing the volatility and relationship between Real Total Return of and five investment periods including one year, three years, five years, seven years, and ten years for initial period when the large capital stock asset class was twenty-five percent (25%) under the mean trend line of the asset class and when the capital stock asset class was twenty-five percent (25%) over the mean trend line of the asset class.

### DESCRIPTION OF EMBODIMENTS

Asset allocation strategy is an important part of an overall investment strategy. Embodiments of a method of optimizing an asset allocation strategy, comprising calculating a difference between a current value of an asset class with a trend line of the historic values of the first asset class. This difference between the current value of an asset class and a trend line of the historic values of the asset class provides an indication of the future return of the asset class and the volatility of the future values. Historically, if the current value of the asset class is below trend line of the historic values, the value of the asset class has tended rise and, thus, to revert to the trend line. As such, the value of a particular asset class tends to revert to an asset class trend line. In embodiments of the method, the trend line of historical values may be a linear or mean trend line or the historic points may be fitted to a curve such as a nonlinear regression or a regression with multiple variables to determine the historic price line, hereinafter “mean trend line”. The trend line may be a multivariable equation, wherein the additional variables could include the associated inflation value or slope of the trend line, for example. In certain embodiments, the trend line will be a linear trend line although a logarithmic function is more common.

The difference between a current value of an asset class with a trend line of the historic values of the asset class may be used to estimate or indicate an expected asset class future value and the volatility in future values of the asset class after certain investment periods. The expected asset class future value and the volatility may be estimated by the response of the asset class in other periods of similar asset class valuation. From the historic data, a distribution of asset class future values may be calculated by a computer implemented modeling software or other computer implemented method. The distribution of asset class future values indicates the probability that the value of asset class will rise and fall in value and the extent of the rise and fall historically. In this regard, the definition of “risk” may be redefined more clearly as chance of not meeting an investment goal at the investment horizon. An investment horizon is defined at the a future time when the money in an investment is expected to be needed, for example, at retirement, for a college education, purchase of second home or other financial need. The distribution of future values will indicate the lowest potential movement of the asset class, the highest potential movement and an expected normal movement of the values based upon the historic responses to a difference from trend.

This distribution may be used to determine an investment strategy including the percentage of the value of a investment portfolio to be allocated into the asset class. If the method is performed for a plurality of asset classes, the estimated future values and the potential volatility of each class may be used to develop a strategic asset class allocation for an individual or group of investors based upon their specific needs and an investment period.

Embodiments of the method of strategic asset allocation and the models should look beyond the multi-month fluctuations inherent in financial markets and develop a long-term, multi-cycle forecasts of potential returns and downside risks for the major asset classes considering investment goals and investment horizon. These forecasts of risk or volatility and potential return may be incorporated into an optimization framework that calculates the combination of asset classes offering the maximum potential return for the accepted degree of risk. For a complete analysis, the analysis can be performed over various investment periods. The appropriate investment periods may be determined by the investment horizon and in some cases will include the investment horizon and at least one additional investment period close to the investment horizon. The risk may then be determined by comparison of the analysis for each investment period.

As used herein, “asset class” means a category of potential investment vehicles including, but not limited to, cash including, for example, money market funds; bonds including, for example, investment-grade bonds, junk or high-yield bonds, government bonds, corporate bonds, short-term bonds, intermediate term bonds, long-term bonds, domestic bonds, foreign bonds, and emerging markets bonds; stocks including, for example, value or growth stacks, large capital stocks, small capital stocks, public equities, private equities, domestic, foreign, and emerging markets; real estate or real estate investment trusts; foreign currency; natural resources including, for example, oil, coal, cotton, and wheat; precious metals; collectibles including, for example, art, coins, or stamps; and insurance products including, for example, life settlements, catastrophe bonds, and personal life insurance products. These investment vehicles may be further categorized by into additional asset sub-classes, for example, by size, for example, large capital, mid capital or small capital or by style, such as by growth, income, or a blend. As used herein, a “Large Capital” or “Large Cap” is a company having a total market capitalization of over ten billion dollars.

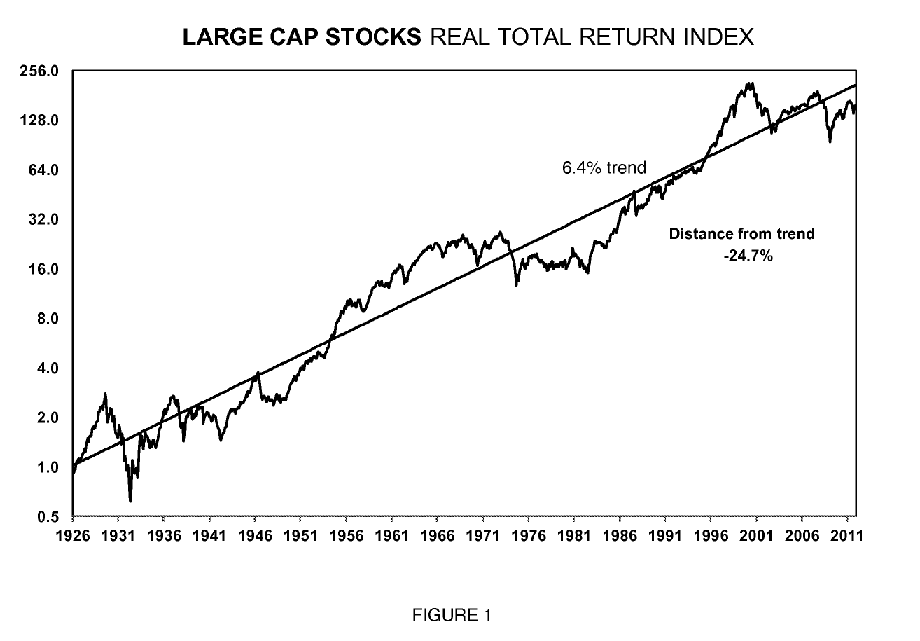

Conventionally, asset allocation strategies have been developed assuming that markets and asset classes respond according to a random walk theory. However, analysis of historical asset class returns on investment suggests that a random walk theory is correct only over extremely short or extremely long investment horizons; not over a typical investment period for an investment portfolio. Over one year time horizons (as typically used in conventional asset allocation strategies), market returns do appear to be almost completely random, as the interplay of investors' emotions such as fear and greed, outweigh any valuation considerations. However, as exemplified by a graph of the historic values of Large Cap stocks in FIG. 1, asset classes do indeed consistently provide returns fairly close to the long-term average over long investment periods such as, for example, thirty or forty years. The trend line on FIG. 1 shows a 6.5% increase value of large cap stocks over a long period of time. However, typical investors may have investment goals that need to be met in 5, 10, or even 20 years, such as, for example, children's college education costs or money for retirement. Over these time horizons, investment returns are neither completely random nor consistent with the long-term average returns. Rather, for three, five, and ten year investment periods, the distance from the long term trend at the start of the investment period has a strong influence on subsequent investment returns. Over these intermediate time periods the historical tendency of markets to revert to their long term trend (in the case of large cap stocks, a 6.5% long term trend line) has time to exert a strong influence on returns.

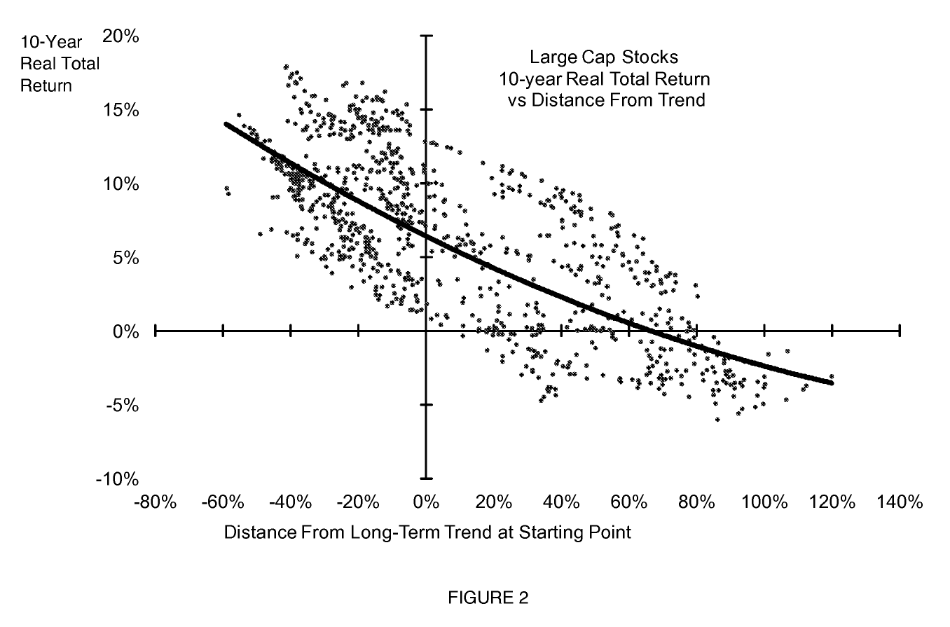

The evidence for this mean reverting tendency in financial markets shown is in FIG. 2. Each point on the graph represents an observation for large cap stocks from a specific date (e.g., March 1926 or June 1968). On the left side of the chart are observations from periods starting with large cap stocks trading below the long-term 6.5% trend line (prices were low), while the right side of the chart shows periods starting large cap stocks above the long-term trend (prices were high). The total return for each of these observations over the subsequent 10-year investment period shown on the vertical positions on the chart—the higher up the chart, the greater the return. Our analysis of this historical data shows that when prices start from well below the historical trend, 10-year returns have been above average. Conversely, periods that begin with above-average prices, having values above the trend line, have tended to produce below-average returns. Markets exhibit a strong mean reversion tendency that is not reflected in industry standard capital market assumpations and asset allocation optimization methodologies.

Embodiments of the method comprise calculating regression equations from the historical data for a plurality of asset classes to determine a trend line. The current value of the asset class is compared to this regression equation or trend line to determine the difference between the expected value based upon the regression analysis or the trend line and the current value. The method may then further comprise calculating a distribution of future values. From the distribution, an expected future value of the asset class and/or an expected return and potential volatility of the investment class from the current valuation for one or more investment periods may be estimated. This is grounded in historic data because the distribution is based upon historic responses of the asset class to the difference between the current value and the trend expected value. For example, the average 1-year, 3-year, 5-year, 7-year and/or 10-year returns produced by the asset class at each difference as observed in the historical data. In specific embodiments to calculate CMAs, we determine the distance above or below trend for a particular asset class and input that level into the regression equation.

For example, the large cap market in 2010 was about 20% below its long-term trend line as shown in FIG. 1. Using a −20% difference in the regression equations indicates that the average return for the historical observations is about 8% above inflation, suggesting that (absent other considerations beyond historical mean reversion) investors are likely to experience above-average returns in large-cap stocks for an investment period of 10 years from this starting point.

Typically, upon calculating CMAs using mean reversion concepts, asset allocators have resorted to standard mean variance optimization (MVO) or resampling approaches in order to turn these CMAs into usable asset allocation strategies. The challenge in such a mixed approach is that the mathematics within MVO or resampling are based on one period (typically 1-year) time frames, a time frame too short for mean reversion to exert much influence. Thus mean reversion is incorporated into the initial inputs to the optimization but not adjusted appropriately during the optimization itself.

For example, asset allocation strategies are typically determined using monte carlo methods and embodiments of the method of the invention are conducted using monte carlo methods. Generally, monte carlo methods are a class of analytical techniques using computational algorithms that rely on repeated random sampling to compute their results. Monte carlo methods are often used in simulating physical and mathematical systems. These methods are most suited to calculation by a computer and tend to be used when it is infeasible to compute an exact result with a deterministic algorithm.

Monte carlo methods are useful for simulating systems with many coupled degrees of freedom, such as asset allocation strategies for investment portfolios. Monte Carlo methods vary, but tend to comprise the same steps, defining a domain of possible inputs, generating inputs randomly from a probability distribution over the domain, perform a deterministic computation on the inputs, and aggregate the results. In this case, the domain of possible inputs is the distribution of expected returns developed from the difference from trend analysis. For more accurate monte carlo simulations, the inputs should be as random as possible within the domain and there should be a large number of inputs. The monte carlo method may be performed for portions of the investment period or the investment horizon. In this case, embodiments of the method of asset allocation comprise recalculating the domain of possible inputs or the distribution of expected returns based upon the distance from trend of the expected value resulting form the first interation. Also, the capital market assumptions are not static throughout interations of the monte carlo method but are variable based upon the outcome of the first iteration. Capital market assumption may comprise expected return at a future date, asset class volatility, and asset class correlations. For example, during typical market conditions the correlation between high yield bonds and large cap stocks is approximately 0.3. However, during sudden declines in the large cap market or sudden bear market declines, this correlation between the value of high yield bonds and large cap stocks rises to approximately 1. Thus, them method includes adjusting the capital market assumptions in each interation.

Furthermore, the concept of mean reversion is inherently inconsistent with standard deviation of historical returns as the sole measure of risk. As shown in Chart 1, in the late 1990s the smooth, steady assent of equity prices reduced the standard deviation of returns and, therefore, risk as measured by industry standard practices. However, under mean reversion concepts, risk was steadily increasing over this period as markets climbed further and further above their long term trend. The converse situation was observed in early 2009, as highly volatile markets in the wake of the financial crises elevated standard deviation levels at the same time that measures of distances from trend suggested that risk was rapidly declining. Thus to reflect mean reversion concepts the optimization process must go beyond standard deviation of returns as a measure of risk.

Embodiments of the methods and the optimization process described addresses these shortcomings of the prior art, As detailed below, mean reversion optimization uses a multi-period simulation of potential returns. Potential returns are calculated based upon the distance from trend line at each time step in the simulation. The simulation of potential returns further extends beyond the concepts within industry standard techniques by allowing for correlations between asset classes to spike during market crises, allows for “black swan” downside risks, and other assumptions that more accurately reflect actual historical market behavior. As used herein, a “black swan” is an event that lies outside the realm of regular expectations of the past thus one may not be able to convincingly point to its possibility and the black swan carries an extreme impact. The methods of optimization build upon a definition of risk that goes beyond one period standard deviation of returns and looks at portfolio valuations at multiple forward points in the simulation, incorporating mean reversion tendencies into the risk assessment and allowing the investor's time horizon to be explicitly incorporated into risk calculations.

Mean reversion optimization (MRO), as with traditional techniques, seeks to optimize the potential return of the portfolio subject to a specific level of risk. However, embodiments of the method of the invention define risk far differently from industry standard approaches. Traditional optimization techniques measure risk exclusively as volatility—the standard deviation of historical market returns. These traditional tools typically seek to build an asset allocation that offers the highest potential 1-year return for the amount of volatility (risk) assumed. Such a measure of risk assumes markets are normally distributed, yet markets tend to produce large losses (greater than 3 standard deviations from the mean) more often than would be expected from a true normally distributed process. Such a measure of risk assumes markets further assumes that correlations between asset classes are relatively fixed, while in practice correlations tend to be highly variable and the level of correlation highly dependent upon the market environment (correlations across most asset classes tend to increase in extremely volatile markets).

The methods of mean reversion optimization define risk the way investors do. Risk is defined as the probability of losing money, typically the probability of losing money at the investment horizon. The probability of losing money for each asset class is then determined by a simulated range of outcomes at each time horizon that approximates the historical experience for periods beginning at the current difference from the trend line. By ensuring that simulated returns approximate historical outcomes, this process ensures that “fat tailed” returns beyond those considered by MVO occur within MRO in approximately the same proportion as such “black swans” have been observed historically. As used herein, a “fat tailed” distribution is a distribution that has a rounder peak and is weighted heavier on one tail indicated the increase chances of loss in the asset class than a normal distribution. The simulation further improves upon industry standard techniques by assuming that markets periodically go into “crises mode”, during which correlations between asset classes will approach historical maximums. The optimization process seeks the combination of asset classes with the highest potential return subject to a low probability of loss across investors' specific investment horizon.

Thus, our definition of risk combines volatility, time horizon, fat tail events, correlation spikes, and valuation levels into a single risk metric. In modeling risk within MRO, the first step is to ensure that the simulation allows for a higher probability of large losses (black swans) than is contained within a normal distribution. To accomplish this goal, the MRO Monte Carlo simulation uses random numbers with in the historic distribution that has been computed with “fat tails” that approximately correspond to the number of 4 and 5 standard deviation events observed in the historical record. Real returns from historical data are used within a non parametric distribution fitting process and Pareto distribution. This fitted distribution serves up pseudo random numbers within the simulation that produce fat tailed events that approximately match the historical experience. This is not done in conventional asset allocation methods.

A further dimension of risk that cannot be assessed in traditional optimization methods is investment horizon. Higher volatility asset classes can serve up substantial declines over shorter investment periods. However, mean reversion suggests that over longer investment horizons painful declines tend to be somewhat offset by positive returns and investors with the ability to remain invested for longer time frames have a higher probability of receiving these offsetting positive returns. Traditional tools can only roughly approximate how different time horizons may equate to different levels of portfolio volatility. Since the probability of mean reversion (either positive or negative) rises with time horizon, MRO explicitly incorporates time horizon into the assessment of risk and optimizes the combination of asset classes subject to a specific investment horizon.

Once time horizon is incorporated into the measure of risk, the distance from long term trend must also be incorporated because over longer term horizons overvalued asset classes are more likely to fall in value than lower priced alternatives, and once they fall they tend to fall further. By the same token, asset classes close to the maximum distance below trend observed in the past could be viewed as having a lower than average risk level since the historical record suggests positive returns are more likely than negative ones from such depressed valuation levels, provided the investors' time horizon provides for sufficient time for mean reversion to exert its pull on market returns.

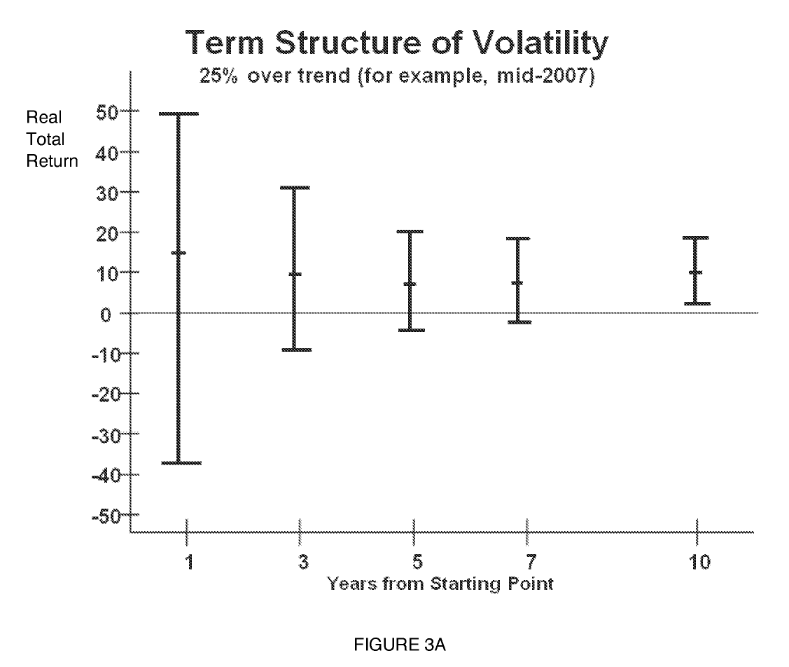

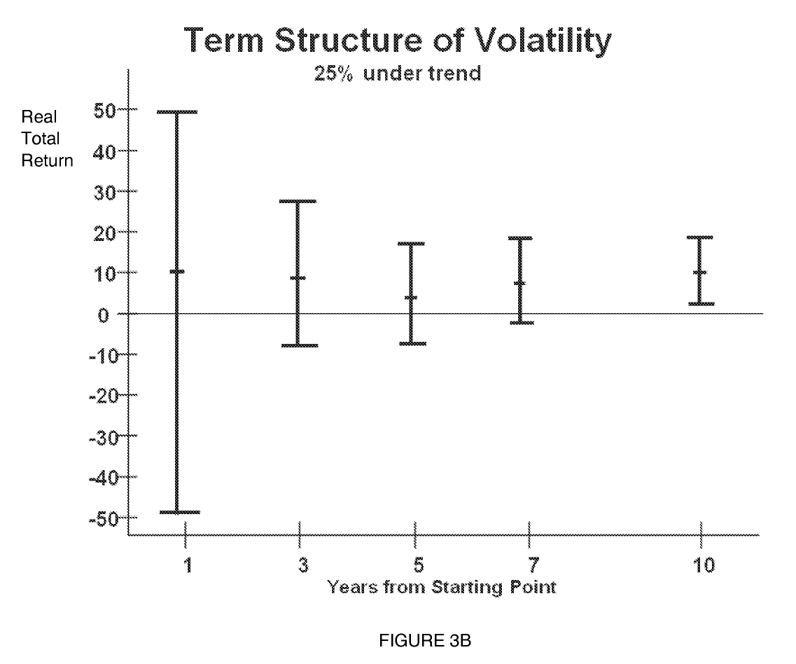

The charts in FIGS. 3A and 3B show large cap returns for 1- through 10-year historical investment periods. The chart in FIG. 3A shows the expected returns and volatility from all historical periods that began with large cap stocks priced about 25% above the long-term trend line value. Large Cap stock reached a value of 25% greater than the trend line near the peak of the market in the fall of 2007, for example. The bars at each investment period reflect all historical periods that began with valuations close to this difference of about 25% above the long-term trend. The chart shows that the probability of experiencing severe 1-year declines (or substantial gains) is primarily a function of asset class volatility. Whether the market is 25% over or undervalued does not change the distribution range of 1-year returns appreciably. Thus for short time periods the volatility of an asset class is by far the most important measure of risk (lower volatility asset classes such as investment grade US bonds have never produced such short term losses). However, as the time horizon lengthens valuation levels (price) become more and more important in measuring overall investment risk.

History shows the potential for declines of up to 45% over a 1-year period when the market is priced at 25% over trend. Large cap stocks came very close to experiencing such a decline in the crash of 2008/early 2009. However, the lowest three-year recorded annualized return for comparably priced markets has been a loss of about 18%. That means that market returns for the two years subsequent to the 45% decline were slightly positive even in the worst periods of market history. The odds of offsetting positive returns becomes even greater over five years (worst-case returns of about −10%) and still greater at the 7- and 10-year horizons. Since the odds of a big loss drop significantly over longer investment periods, time horizon has a significant impact on risk.

Price also has a powerful impact on risk. For periods that began 25% above the long-term trend, even investors with a 10-year investment horizon face little better than a 50/50 change of making money. Contrast that with the green bars, which show returns for markets that began with levels of 25% below trend. Unfortunately, potential losses at the 1-year level are only slightly better than the overvalued market (emotion typically trumps price over shorter time periods). Worst-case losses at the 3-year period, however, are about half those of the overvalued markets, and by the 5-year horizon, downside risks are less than 3% per annum as compared to a potential upside of nearly 20%. As time horizons extend, the risk/reward benefits become even more favorable, because historically large-cap equity markets have never produced a loss across a 10-year period that began with valuations 25% below trend.

Asset class volatility must be a part of any model of risk, because over shorter time frames these asset classes can experience larger losses, and buying at an attractive price offers little short-term protection (cheap asset classes can get even cheaper). However, the traditional focus on volatility as the sole measure of risk can cause critical investment mistakes. First, by not incorporating mean reversion into its measure of risk the standard deviation of historical returns may understate risk by declining just as actual market risks are rising (and vice versa). Furthermore, because traditional optimization techniques do not incorporate the investor's time horizon into the risk calculation, investors must guess as to what level of volatility is appropriate for their investment requirements, and can lose confidence in portfolio strategies that require sufficient time for mean reversion to have an impact on returns. Thus investors can be lured into increasing risks during rising markets or decreasing risks after market declines. By incorporating time horizon and valuation into the model of risk, MRO provides a more comprehensive measure of risk and better measures of risk should produce more suitable asset allocation solutions.

Embodiments of the invention include selecting the combination of asset classes that offers the highest potential return subject to meeting the criteria of low probability of loss across a specific investment horizon that meets the goals of the investor. The specific combination of asset classes that meets this low probability of loss test is highly dependent upon current valuation levels. For example, an investor with a 3- to 5-year time horizon can accommodate a higher proportion of large cap stocks when that asset class is 25% below its long term trend than when (as in 2007) large cap stocks were 25% above trend. This is because the maximum loss experienced from the lower valuation level is much lower and therefore the amount of less risky, lower volatility, lower returning assets can be lower as well. Similarly, an investor with a 5 to 7 years investment horizon can accommodate a substantially higher allocation to large cap stocks than an investor with a shorter time frame, since the 2% to 3% maximum loss for large cap stocks over that time frame requires far less of an offset to provide a reasonable probability of a net positive return.

By defining risk as the probability of losing money and by incorporating price and time horizon into the calculation of risk, MRO better aligns the asset allocation strategies to a client's true risk tolerance as market conditions change. For example, should large cap stocks return to the 25% overvalued position of 2007, the allocation to large cap stocks for both 3-5 year and 5-7 year investors would fall significantly since the magnitude of potential losses at those time horizons would be much greater.

The 1-year (or 1 period) assumption within traditional optimization techniques allows these processes to avoid the question of how input assumptions might change in a multi-period framework. Since MRO explicitly models multi-period asset class returns, this methodology must provide for an evolution of expected returns and downside risks based upon the outcomes of specific trials within the simulation. Embodiments of the method for asset allocation use historical data to estimate expected average returns based upon starting distance from trend conditions. As these distance from trend values change along a particular simulation trail, these equations are applied to vary expected returns and downside risks based upon the new valuation levels which are dependent upon the previous outcome. The application of these equations within the simulation ensures that mean reversion concepts are applied throughout the simulation trail, and not just in establishing initial market conditions. The accuracy of the simulation through the application of these equations is checked and additional variance reduction techniques are applied until the term structure of volatility within the simulation approximates that of the historical record for each of the simulated asset classes.

With a robust measure of risk and a multi-period simulation of mean reverting returns, the final optimization process is extremely straightforward. The set of all asset class combinations that meet the criteria of low probability of loss at a specific time horizon is identified (the primary optimization constraint). The asset allocation solution is that combination of asset classes that meets this test (along with other, more subjective constraints such as asset class concentration) while offering the highest upside potential. Upside potential is measured as either the highest average return across the simulation or the highest absolute return, depending upon the preference of the analyst. Embodiments of the method may be calculated after adjustment for inflation.

Embodiments of the mean reverting simulation may comprise selecting a first asset class as a basis such as large cap stocks as the “driver” asset class for the simulation. A better approach to the simulation is currently under development and will use inflation rather than an asset class as the driver for the simulation. Inflation shows a definitive relationship to long term asset class returns and the tendency and speed of mean reversion. This historical relationship is too complex to express using standard Monte Carlo techniques (a covariance matrix, Cholesky decomposition and separately calculated random movement).

Embodiments of the method of asset allocation comprise building the simulation on inflation as the driver and then calibrating simulated return environments and distance from trend levels to the inflation environment will allow a more accurate simulation of real returns (returns over and above inflation). By simulating unprecedented inflationary environments and using historical asset price relationships to inflation, MRO risk analysis could be extended to test the robustness of investment strategies to environments more extreme than have been observed in the US but that have been relatively common in other world economies and markets.

The embodiments of the described methods are not limited to the particular embodiments, method steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

1. A computer implemented method of setting an asset allocation strategy, comprising:
calculating a current difference from trend between a current value of an asset class and the current value predicted by a historic trend line of the value of the asset class for multiple asset classes; and
estimating an expected distribution of asset class future values for multiple investment periods, wherein the expected asset class future values are derived from historical responses of the asset class to the current difference from trend for each investment period and the degree of mean reversion historically observed in each asset class.

2. The computer implemented method of claim 1, comprising
determining an investment horizon based upon investment goals, wherein one of the investment periods is the investment horizon.

3. The computer implemented method of claim 1, comprising:
setting an asset allocation strategy based upon the expected distributions of each asset class.

4. The computer implemented method of setting an asset allocation strategy
allocating a portion of the value of a investment portfolio into each asset class based upon the expected asset class future value.

5. The computer implemented method of claim 1, comprising defining an acceptable level of downside risk at the investment horizon and solving for an combination and ratio of asset classes that ensures meets the acceptable level of downside risk and maximizing the upside potential.

6. The computer implemented method of claim 1, wherein the estimating an expected asset class future value and the expected distribution of asset class future value at each investment period is performed by a monte carlo method.

7. The computer implemented method of claim 6, wherein each monte carlo trial comprises a set of capital market assumptions, wherein the capital market assumptions of a subsequent monte carlo trial are recalculated based upon the results of the previous monte carlo trial.

8. The computer implemented method of claim 7, wherein the set of capital market assumptions comprises expected return at a future date, asset class volatility, and asset class correlations.

9. A computer implemented method of setting an asset allocation strategy, comprising:
calculating expected distribution of asset class future values at multiple investment periods by a monte carlo method for multiple asset classes.

10. A computer implemented method of setting an asset allocation strategy, comprising
calculating expected distribution of asset class future values by a monte carlo method for multiple asset classes using capital market assumptions, wherein the capital market assumptions of a subsequent monte carlo trial are recalculated based upon the results of the previous monte carlo trial.

11. The computer implemented method of claim 10, wherein the set of capital market assumptions comprises expected return at a future date, asset class volatility, and asset class correlations.
